(19) United States
(12) Patent Application Publication
(10) Pub. No.: US 2017/0077657 A1
(43) Pub. Date: Mar. 16, 2017

(54) PROTECTIVE PLATE FOR A PLUG CONNECTOR SYSTEM

(71) Applicant: HARTING ELECTRIC GMBH & CO. KG, Espelkamp (DE)

(72) Inventors: Bernard Schlegel, Rahden (DE); Irina Loetkemann, Espelkamp (DE)

(21) Appl. No.: 15/122,900

(22) PCT Filed: Nov. 19, 2014
(86) PCT No.: PCT/DE2014/100407

§ 371 Date: Aug. 31, 2016

(30) Foreign Application Priority Data
Apr. 7, 2014 (DE) 10 2014 104 902.0

(51) Int. Cl. H01R 13/73

(52) U.S. Cl. CPC H01R 13/73

(57) ABSTRACT

Provided is a protective plate for at least one plug connector attached to a mounting rail, said protective plate having a substantially U-shaped basic form with a closed main surface and side surfaces angled at approximately 90° to the main surface, wherein a securing region is angled at approximately 90° to the side surfaces, said securing region having at least one hole, and wherein an abutting region is angled at approximately 90° to the side surfaces, said securing region and the corresponding abutting region being positioned approximately perpendicular to one another. The system, formed by protective plate, a mounting rail and at least one plug connector, is optimally coordinated.

The invention relates to a protective plate for at least one plug connector secured to a mounting rail according to the preamble of independent claim 1. The invention also relates to a system consisting of a protective plate, a mounting rail, and at least one plug connector according to the preamble of independent claim 4.

Protective plates of this type cover plug connectors arranged in a row on a mounting rail and protect these, for example against damage during harsh everyday operation.

### PRIOR ART

Document EP 2 681 813 A1 presents high-power plugs which can be arranged in a row on a mounting rail. The plastic housing body of these high-power plugs can be damaged in harsh industry conditions, which can lead to a failure of the plug connector and potentially also to a safety risk.

### PROBLEM

The problem addressed by the invention is that of safely, economically, and effectively protecting plug connectors arranged in a row on a mounting rail.

The problem is solved by the characterizing features of independent claim 1.

Advantageous embodiments of the invention are specified in the dependent claims.

The protective plate according to the invention is intended for at least one plug connector secured to a mounting rail. The protective plate has a substantially U-shaped base form, with a closed base area and side faces angled at approximately 90° thereto. Here, the term ‘closed’ means that the base area does not have any bores or the like arranged above the plug connector. The purpose of the protective plate is to cover the plug connector and to protect it, for example against mechanical damage.

The base area advantageously has recesses in the direction of each of the side faces. A securing region is angled at approximately 90° to the side faces. The securing region comprises at least one bore.

A contact region is angled at approximately 90° to the side faces. When protective plates are positioned oppositely, the contact regions of said plates are arranged oppositely, and potentially in contact with each other. It could also be said that the contact regions act as what are known as spacers or buffers.

The securing region and the associated contact region are positioned approximately at right angles to one another.

It has been found that the above-described geometry of the protective plate can be easily produced and offers effective protection for plug connectors arranged in a row on mounting rails. Plug connectors arranged in a row are also referred to hereinafter as plug connector systems.

The contact region has a fixing edge angled at approximately 90° or slightly more than 90°, which is oriented approximately parallel to the fastening region. This fixing edge engages in an undercut of the mounting rail and ensures that the protective plate does not fall off from the mounting rail, even if it is not secured in another way thereto, for example by screws.

The entire system, consisting of protective plate, mounting rail and at least one plug connector is optimally coordinated in terms of design. The plug connector is fixed on the mounting plate and covered by the protective plate.

The protective plate is advantageously fixed on the mounting rail by means of at least one double-ended stud bolt and an associated nut. The nut ideally also has a hexagon socket opening. This type of fixing is particularly space saving.

The double-ended stud bolt has a thread at both ends. In addition, the double-ended stud bolt has a collar centrally, which has a hexagon socket form upwardly. It can thus be mounted advantageously using a hex key.

Alternatively, the protective plate 1 can be fixed on the mounting rail by means of at least one clinch stud and an associated nut.

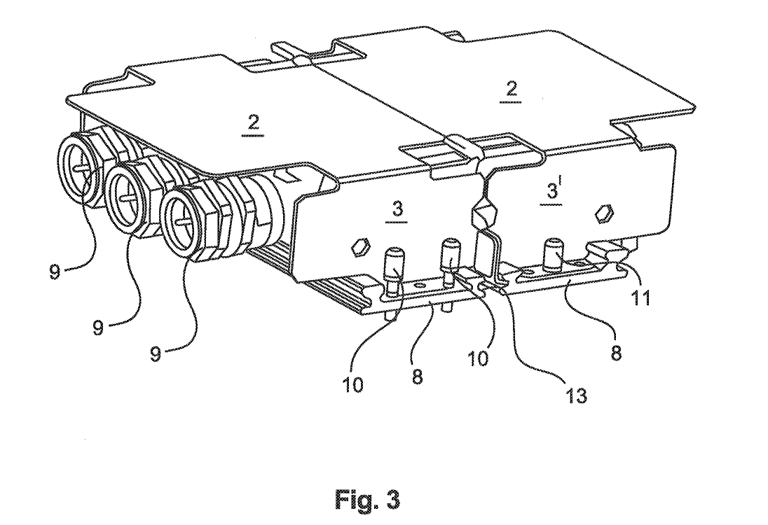

The above fixing alternatives are selected when two protective plates are arranged oppositely, as shown in FIG. 3.

### EXEMPLARY EMBODIMENT

An exemplary embodiment of the invention is illustrated in the drawings and will be explained in greater detail hereinafter. In the drawings:

FIG. 1 shows a perspective illustration of the protective plate,

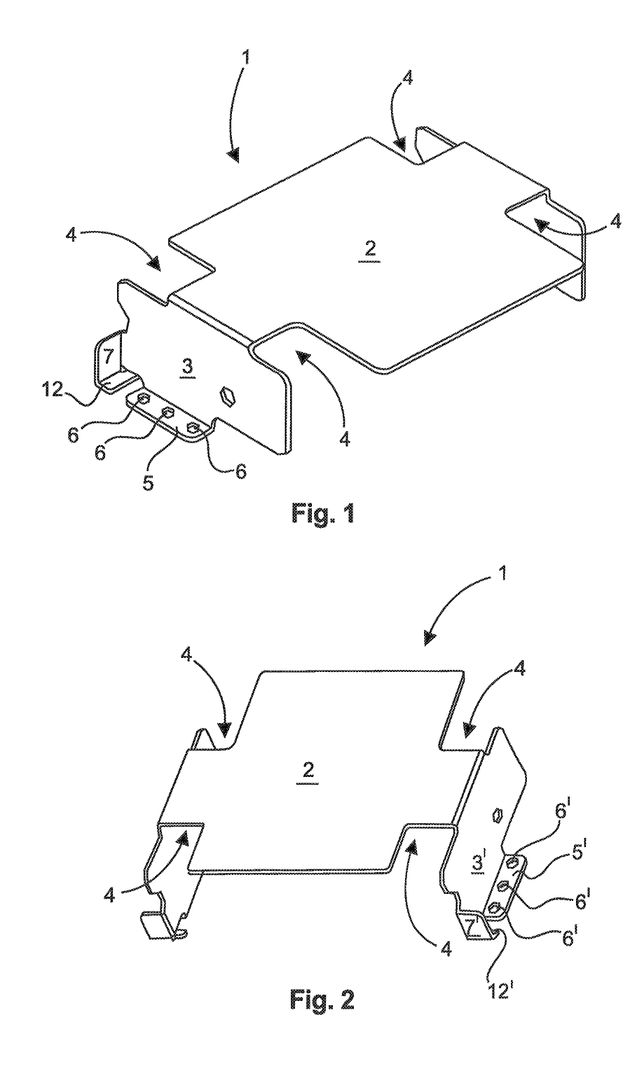

FIG. 2 shows a further perspective illustration of the protective plate, and

FIG. 3 shows two opposite systems, each consisting of protective plate, mounting rail, and plug connector.

The figures contain partly simplified, schematic illustrations. Identical reference signs are sometimes used for similar, but not necessarily identical elements. Different views of the same elements could be scaled differently.

FIGS. 1 and 2 show a protective plate according to the invention, in each case in a perspective illustration. The geometry illustrated here is folded from a steel sheet 1-2 millimeters thick. The steel sheet is processed by means of stamping and bending.

Side faces 3, 3′ are bent at right angles from the main body 2 on both sides. Cutouts or recesses 4 are provided between the side faces 3, 3′ and main body 2. Securing regions 5, 5′ and contact regions bent at right angles thereto are in turn angled at right angles to the side faces 3, 3′.

A fixing edge 12, 12′ is bent away from each of the contact regions 7, 7′. Here, the bending angle is slightly greater than 90°. This fixing edge 12, 12′ engages in an undercut 13 of a mounting rail 8. The protective plate 1 is thus fixed on the mounting rail 8, even without a possible screw connection.

Bores 6, 6′ are disposed in the securing region 5, 5′. The protective plate can be captively fixed on the mounting rail 8 via these bores 6, 6′, for example with the aid of double-ended stud bolts 10 and/or clinch studs 11.

List of reference signs

| | |
|---|---|
| 1 | protective plate |
| 2 | base area |
| 3, 3′ | side face |
| 4 | recess |
| 5, 5′ | securing region |
| 6, 6′ | bore |
| 7, 7′ | contact region |
| 8 | mounting rail |
| 9 | plug connector |
| 10 | double-ended stud |
| | pin |
| 11 | clinch stud |
| 12, 12′ | fixing edge |
| 13 | undercut |
| 14 | |
| 15 | |
| 16 | |
| 17 | |
| 18 | |
| 19 | |
| 20 | |

1. A protective plate for at least one plug connector secured to mounting rail,
which has a substantially U-shaped basic form, with a closed base area and side faces angled at approximately 90° thereto,
wherein a securing region is angled at approximately 90° to the side faces,
wherein the securing region has at least one bore,
wherein a contact region is angled at approximately 90° to the side faces, and
wherein the securing region and the associated contact region are positioned approximately at right angles to one another.

2. The protective plate as claimed in claim 1, wherein
the contact region has an angled fixing edge, which is oriented approximately parallel to the securing region.

3. The protective plate as claimed in claim 1, wherein
the base area has recesses in the direction of each of the side faces.

4. A plug connector system comprising a protective plate, a mounting rail, and at least one plug connector, wherein
the plug connector is fixed on the mounting plate and is covered by the protective plate.

5. The system as claimed in claim 4, wherein
the protective plate is fixed on the mounting rail by at least one double-ended stud bolt and an associated nut.

6. The system as claimed in claim 4, wherein
the at least one double-ended stud bolt has a thread at both ends,
and in that the double-ended stud bolt has a collar centrally, which has a hexagon socket form upwardly.

7. The system as claimed in claim 1, wherein
the protective plate is fixed on the mounting rail by at least one clinch stud and an associated nut.

8. The protective plate as claimed in claim 2, wherein the base area has recess in the direction of each of the side faces.

9. The system as claimed in claim 5, wherein
the at least one double-ended stud bolt has a thread at both ends,
and in that the double-ended stud bolt has a collar centrally, which has a hexagon socket form upwardly.

10. The system as claimed in claim 6, wherein
the protective plate is fixed on the mounting rail by at least one clinch stud and an associated nut.
